(19) United States
(12) Patent Application Publication
(10) Pub. No.: US 2018/0359639 A1
(43) Pub. Date: Dec. 13, 2018

(54) Methods and Systems for Protecting Computer Networks by Masking Ports

(71) Applicant: Francesco Trama, Pittsburgh, PA (US)

(72) Inventor: Francesco Trama, Pittsburgh, PA (US)

(21) Appl. No.: 15/620,157

(22) Filed: Jun. 12, 2017

(51) Int. Cl. H04W 12/08; H04L 29/06; H04W 12/04; H04W 48/04; H04L 12/26

(52) U.S. Cl. CPC H04W 12/08; H04L 63/107; H04L 63/20; H04L 43/18; H04W 12/04; H04L 63/0263; H04W 48/04; H04L 63/061

(57) ABSTRACT

A network security system and method is disclosed that ensures that only authorized devices can communicate with a protected computer network. The network security system has one or more processors configured to execute computer-executable instructions and memory storing computer-executable instructions that are written to implement a security device having a monitor module and at least one monitoring port configured to receive an access request from a remote device comprising a sequence of network port calls. The monitor module then verifies the sequence and provides the remote device with access to a port to communicate with the protected computer network or denies the access if the provided sequence of port calls is incorrect.

### FIELD OF INVENTION

The invention relates to systems and methods for providing security to a computer network by masking network ports or portals that provide access to the computer network.

### BACKGROUND OF INVENTION

Enabling secure communication over global computer networks requires the ability to selectively control access to those networks. Existing security systems, however, are impractical for managing large enterprises that have traveling customers or employees who need access to secure portals because those existing systems have security vulnerabilities and bloated rule sets.

Global computer networks must limit access to public network ports to provide better protection and to reduce security chaos. Firewalls or other mobile security products are an essential component in a network security plan. These devices provide a secure perimeter to a protected environment. However, it can still be necessary to expose network ports in the perimeter to provide access to external systems and networks.

FIG. 1 illustrates a server 20 housing a conventional firewall 22. Mobile client 10 utilizes the internet 12 to connect to the server 20 that includes a conventional firewall 22 having a network port 24. The port 24 provides access to a virtual private network (VPN) 26 that connects to an authentication component 28 so the system can verify proper access of the user and mobile device to and through the firewall 22. The port 24 can be a TCP 443, UDP 500, or some other network port which the server 20 designates. The authentication component 28 can connect to a secure application 30 through a local-area-network (LAN) 32. The port 24 can be a static network port that is exposed on the security perimeter.

Other known embodiments of server 20 expose the port 24 (or a specific set of network ports) unabated on the internet 12. Other embodiments display the secure network port 24 (or ports) when they are required to be enabled for secure communication with the secure application 30. In such embodiments, the server 20 exposes the port 24 to the internet 12 to facilitate open selling practices or to make the application 30 widely available to mobile devices 10. The port 24 can be easily identified and exposed to probe 40 that can explore for vulnerabilities.

In some embodiments, a server 20 can be used to limit access to the secure application 30 by country, by company, and/or by originating network. However, this may not be sufficient for some organizations who have a need for mobile customers or employees, who can be located anywhere in the world, to be able to securely access the secure application 30. In such a scenario, limiting access based upon country, company, network or IP address can be impractical because it can require security administrators to make special rules for the mobile devices to ensure secure and safe access without creating unnecessary vulnerabilities.

Another embodiment of an existing system is illustrated in FIG. 3. In this embodiment, a mobile client 100 connects over the internet 110 to a server 120. The server 120 includes a security component 122 that includes a firewall 124, a geo-ip filter 126, and a network port 128. The network port 128 provides access to VPN 130, authentication component 132, LAN 134, and secure application 136.

The firewall 124 can be a packet inspection security device. The security component 122 can configure and implement the geo-ip filter 126 to cooperate with the firewall 124 to provide accessibility to legitimate mobile users, such as mobile client 100, to the secure network port 128.

Other existing systems limit access by country and/or by company. However, such systems are not suitable when there is a large enterprise that spans multiple countries or has a large roaming mobile footprint (i.e., a large group of traveling employees or customers). Such systems require the enterprise to expose secure portals to a substantial number of mobile devices, which increases security vulnerabilities. Moreover, existing systems that filter access from particular parts of the world run the risk of blocking traveling mobile users. As a result, there is a need for an improved security system for computer networks that can overcome these limitations.

Existing security devices are forced to leave network ports open to provide an active channel for communication. The disclosed invention closes such exposures, eliminates open channels to secure applications that can be exploited by potential attackers, and directly addresses the problem of securing a network perimeter for systems that communicate with mobile agents.

### SUMMARY OF INVENTION

The present disclosure enables a mobile client to remotely and securely access a destination server's secure network ports by transmitting the correct sequence of network ports in the correct order and within a predetermined amount of time. If the correct sequence is timely received and access granted, the system can be directed to write new network firewall rules as the mobile agent moves from location to location. The disclosed system does not require a user to leave critical network ports permanently open and can make dynamic network rule changes for the next communication cycle in the event that the mobile agent moves to a different network of origin.

In order to overcome the limitations of existing systems, a request from a mobile client to access the computer network must request the correct sequence of no less than two (2) different network ports within a predetermined timeframe. A monitor service monitors and confirms the correct network port sequences, and captures the mobile client's IP address, and stores the client network information. A rules generator then uses the monitor service data to generate and write network firewall rules dynamically that permits the mobile client to continue to access the destination network port from its current source IP address for a limited time. This access sequence then repeats when the mobile agent changes network space or attempts to gain access to the protected network from a different IP address.

### BRIEF DESCRIPTION OF THE DRAWINGS

For a fuller understanding of the nature and advantages of the invention, reference should be made to the following detailed description, taken in connection with the accompanying drawings, in which:

FIG. 1 illustrates a prior art firewall protecting a computer network.

FIG. 2 illustrates both an attacker and a mobile client attempting to access a prior art server through the internet.

FIG. 3 illustrates a prior art firewall with a geo-ip filter protecting a network.

FIG. 4 illustrations an embodiment of the present invention.

FIG. 5 illustrates another exemplary system in accordance with another embodiment of the invention.

FIG. 6 illustrates another exemplary system in accordance with another embodiment of the invention.

FIG. 7 illustrates a process in accordance with the embodiment of the invention.

FIG. 8 illustrates an exemplary system in accordance with an alternative embodiment.

FIG. 9 illustrates a process in accordance with the embodiment of the invention.

FIG. 10 illustrates a continuation of the process illustrated in FIG. 9.

FIG. 11 illustrates an aspect of an alternative embodiment consistent with the present invention.

FIG. 12 illustrates another exemplary system in accordance with an alternative embodiment of the present invention.

FIGS. 13A-13B illustrate a process that implements aspects of the embodiment of the invention shown in FIG. 6.

### DETAILED DESCRIPTION OF THE INVENTION

The following detailed description includes the best currently contemplated modes of carrying out exemplary embodiments of the invention. The description is not to be taken in a limiting sense, but is made merely for the purpose of illustrating the general principles of the invention, since the scope of the invention is best defined by the claims included herein.

The invention provides a simple and practical method for mobile clients to be identified and managed through a computer network security system. Network administrators can control availability of network ports by making them unavailable until a series of network ports are requested in the correct order by an authorized mobile client. Absent the special combination of port requests, no access to the network is granted. The invention makes the network service unavailable to all external traffic so it cannot be scanned or probed.

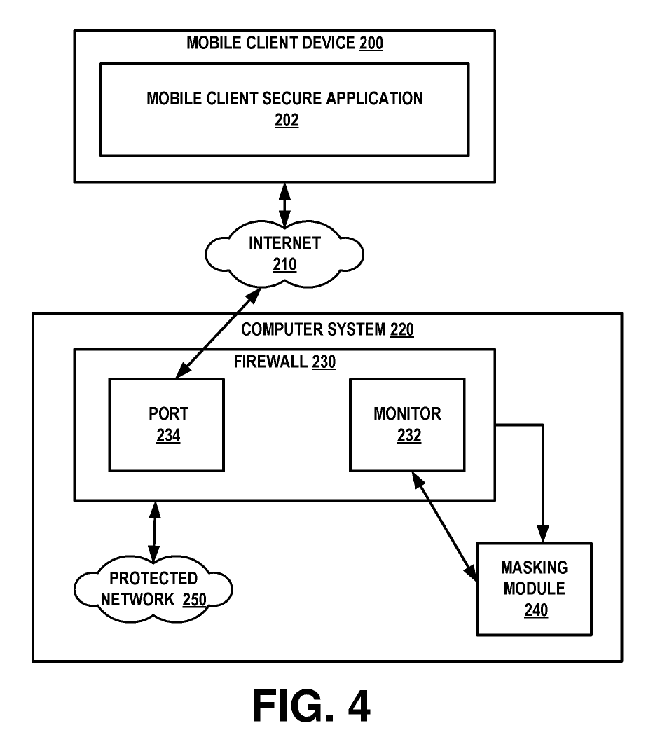

Referring now to FIG. 4, an exemplary embodiment consistent with the present invention is depicted for masking a network port. This exemplary embodiment includes a mobile client device 200 that stores a mobile client secure application 202. It is desirable for mobile client device 200 to communicate with a protected computer system 220 via the internet 210.

Implementations of computer system 220 are described within the context of a system configured to perform various steps, methods, and/or functionality in accordance with aspects of the described subject matter. It is to be appreciated that a computer system can be implemented by one or more computing devices. Implementations of computer system 220 can be described in the context of “computer-executable instructions” that are executed to perform various steps, methods, and/or functionality in accordance with aspects of the described subject matter.

In general, a computer system, such as computer system 220, can include one or more processors and storage devices (e.g., memory and disk drives) as well as various input devices, output devices, communication interfaces, and/or other types of devices. Exemplary input devices include, without limitation: a user interface, a keyboard/keypad, a touch screen, a touch pad, a pen, a mouse, a trackball, a remote control, a game controller, a camera, a barcode reader, a microphone or other voice input device, a video input device, a motion sensing device, a gesture detection device, and/or other type of input mechanism and/or device.

A computer system, such as computer system 220, can include a combination of hardware and software. It can be appreciated that various types of computer-readable storage media can be part of a computer system. As used herein, the terms “computer-readable storage media” and “computer-readable storage medium” do not mean and unequivocally exclude a propagated signal, a modulated data signal, a carrier wave, or any other type of transitory computer-readable medium. In various implementations, a computer system can include a processor configured to execute computer-executable instructions and a computer-readable storage medium (e.g., memory and/or additional hardware storage) storing computer-executable instructions configured to perform various steps, methods, and/or functionality in accordance with aspects of the described subject matter.

Computer-executable instructions can be embodied and/or implemented in various ways such as by a computer program (e.g., client program and/or server program), a software application (e.g., client application and/or server application), software code, application code, source code, executable files, executable components, routines, application programming interfaces (APIs), functions, methods, objects, properties, data structures, data types, and/or the like. Computer-executable instructions can be stored on one or more computer-readable storage media and can be executed by one or more processors, computing devices, and/or computer systems to perform particular tasks or implement particular data types in accordance with aspects of the described subject matter.

Computer system 220 can implement and utilize one or more program modules. Generally, program modules include routines, programs, objects, components, data structures, etc., that perform particular tasks or implement particular abstract data types.

Computer system 220 can be implemented as a distributed computing system or environment in which components are located on different computing devices that are connected to each other through network (e.g., wired and/or wireless) and/or other forms of direct and/or indirect connections. In such distributed computing systems or environments, tasks can be performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

As shown, computer system 220 can include servers and workstations, which can be connected by one or more networks. Computer system 220 can be implemented by computing devices such as server computers configured to provide various types of services and/or data stores in accordance with aspects of the described subject matter. Mobile client device 200 can be any mobile electronic device, such as a navigation device, a smartphone, a handheld computer, a tablet, a PC, or any other client device.

The network or networks that connect various components of computer system 220 can be implemented by any type of network or combination of networks including, without limitation: a wide area network (WAN) such as the Internet, a local area network (LAN), a Peer-to-Peer (P2P) network, a telephone network, a private network, a public network, a packet network, a circuit-switched network, a wired network, and/or a wireless network. The components can communicate via the network or networks using various communication protocols (e.g., Internet communication protocols, WAN communication protocols, LAN communications protocols, P2P protocols, telephony protocols, and/or other network communication protocols), various authentication protocols, and/or various data types (web-based data types, audio data types, video data types, image data types, messaging data types, signaling data types, and/or other data types).

The computer system 220 can include servers that can be implemented by one or more computing devices such as server computers configured to provide various types of services and/or data stores in accordance with aspects of the described subject matter. Exemplary server computers can include, without limitation: web servers, front end servers, application servers, database servers, domain controllers, domain name servers, directory servers, and/or other suitable computers.

The server or servers can include a single central server or, in alternate embodiments, can include one or more servers in communication with each other as appreciated by one skilled in the art. The server or servers can include a repository or database for updates and content information. For example, a centralized server can store lists of IP addresses by region, store additional details about the IP addresses, such as host name, location information and the like, include associated information from ‘whois’, as well as include a storing place for receiving system updates and the like as appreciated by one skilled in the art. The repositories on the server or servers can be updated daily or as frequently as desired by querying the Internet Name and Number regulatory authorities daily or when newly discovered IP addresses are discovered.

Components of computer system 220 can be implemented by software, hardware, firmware or a combination thereof. For example, computer system 220 can include components implemented by computer-executable instructions that are stored on one or more computer-readable storage media and that are executed to perform various steps, methods, and/or functionality in accordance with aspects of the described subject matter.

Computer system 220 can include one or more hardware appliances or virtual appliances. A hardware appliance includes a physical box, such as typical server hardware from Dell, HP, IBM, and other hardware providers, that can be racked and set in secure areas as appreciated by one skilled in the art. Hardware appliances can have software programmed thereon. The user can configure the hardware and his or her router to their desired preferences as discussed below to allow real-time regulation of network traffic, such as blocking or dropping traffic, rerouting traffic, logging traffic, and the like, to occur. In embodiments, hardware appliances can be updated periodically, such as daily, monthly, or annually from a server. A virtual appliance includes, for example, an appliance that can be located on a virtual server such as that provided by VMware® and the like as appreciated by one skilled in the art.

Computer system 220 configures and implements aspects of one embodiment of the disclosed invention by configuring and implementing a firewall 230 that includes a monitor 232 at least one port 234 and a masking module 240. In an embodiment, the masking module 240 contains a rules generator. The monitor 232 connects to and communicates with the masking module 240. The port 234 connects to a protected network 250. Mobile client device 200 can access the protected network 250 through the port 234 when port 234 is unmasked.

Computer system 220 can configure and implement the firewall 230 and the masking module 240 on the same server or on separate servers. Computer system 220 can integrate the masking module 240 within the firewall 230. Alternatively, computer system 220 can configure and implement the masking module 240 on a separate security device, such as a router, another firewall, or other similar device.

Computer system 220 can implement and utilize rules to control the flow of traffic through the firewall 230. The rules can be set to accept or block network traffic. Additionally, each rule is assigned a priority. These settings are stored in a database within the computer system 220 that can reside on or within the firewall 230.

Each rule can be a custom rule created to enable the firewall 230 to filter traffic based on one or more criteria such as source IP address or network range, destination IP address or network range, protocol, port, networks, countries, or other criteria as appreciated by one skilled in the art. The rules can be directed to specific geographical lists that correlate country, region, state, city and zip code to IP addresses. The rules can be created for IP groups, logging presences, and setting time constraints based on geographical locations.

Custom rules can be designed to supersede rule evaluation further down the chain. Custom rules can be configured to match the source and destination IP criteria. Custom rules can be created by users to filter traffic based on one or more criteria, such as source IP address or network range, destination IP address or network range, protocol, port, or other criteria.

The masking module 240 communicates with the monitor 232 on the firewall 220. The firewall 220, in turn, notifies the masking module 240 and provides network information to cause the masking module 240 to search for the monitor 232. Once the masking module 240 connects to the monitor 232, the masking module 240 triggers a process or API to write or modify rules for the firewall 230, such as whether to cause the firewall 230 to deny or permit the mobile client device 200 to access the port and, therefore, the protected network 250. As used herein, denial of access is called “masking” and permitting access is called “unmasking” the port. 234.

It should also be understood that the protected network 250 can include a protected website for performing human resources functions, banking functions, investment functions, school portals, medical provider portals, sensitive federal repositories or other functions involving similarly sensitive information. In such instances, the port 234 is a web portal.

In other exemplary embodiments, the port 234 can function as an administrative web portal to provide access to web servers, mail servers, databases, or cloud services management residing on the protected network 250. Alternatively, the port 234 can provide remote access when the protected network 250 includes a remote desktop communication to VMView, Citrix, and/or Secure Shell Access portals. Additionally, the port 234 can provide access to file transfers, FTP, secure file transfer protocol (SFTP) servers or similar protocols or functions that are implemented by the protected network 240.

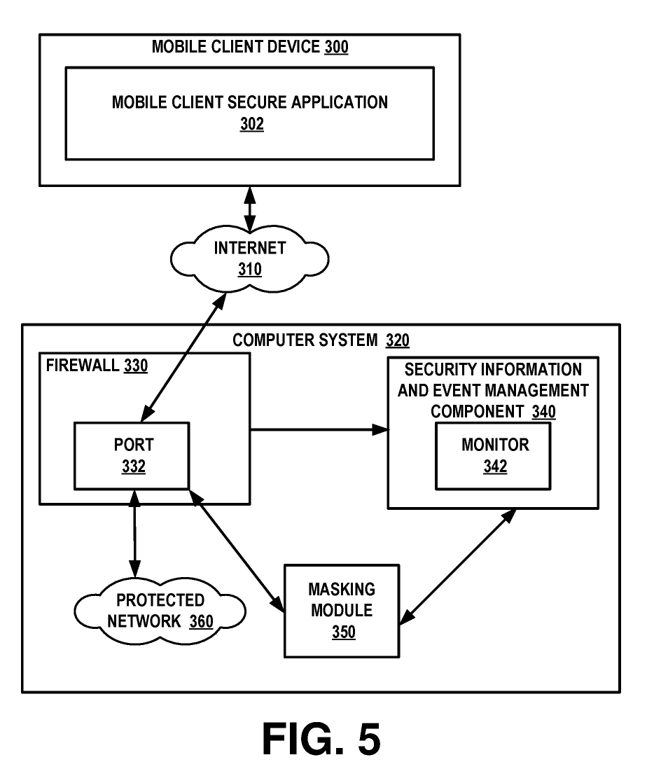

Referring now to FIG. 5 with continuing reference to the foregoing figures, another exemplary operating environment is depicted for masking a network port or portal. This embodiment includes a mobile client device 300 that configures and implements a mobile client secure application 302 and connects over the internet 310 to a computer system 320.

In this embodiment, the computer system 320 configures and implements a firewall 330 that includes a port 332, a security information and event management component 340 (i.e., a SIEM) that includes a monitor 342, and a masking module 350. The monitor 342 connects to and communicates with the masking module 350. The port 332 connects to a protected network 360. The mobile client device 300 can access the protected network 360 through the port 332 when the port 332 is unmasked.

The computer system 320 can configure and implement the firewall 330, the SIEM component 340, and the masking module 350 on the same server or on separate servers. The firewall 330, the SIEM component 340, and the masking module 350 can be configured on a single device or upon multiple devices.

The SIEM component 340 can be a SIEM, an event manager, and/or a syslogger. The SIEM component 340 configures and implements the monitor 342 to communicate with the masking module 350. The computer system 320 searches for the monitor 342. The firewall 330 sends its logs to the STEM component 340 when the computer system 320 finds the monitor 342 to initiate a process or API call by the masking module 350.

The masking module 350 utilizes a process or API to communicate with the monitor 242 on the firewall 330 and to write or modify rules directing the firewall 330 to permit the mobile client device 300 to provide access to the protected network 360, which

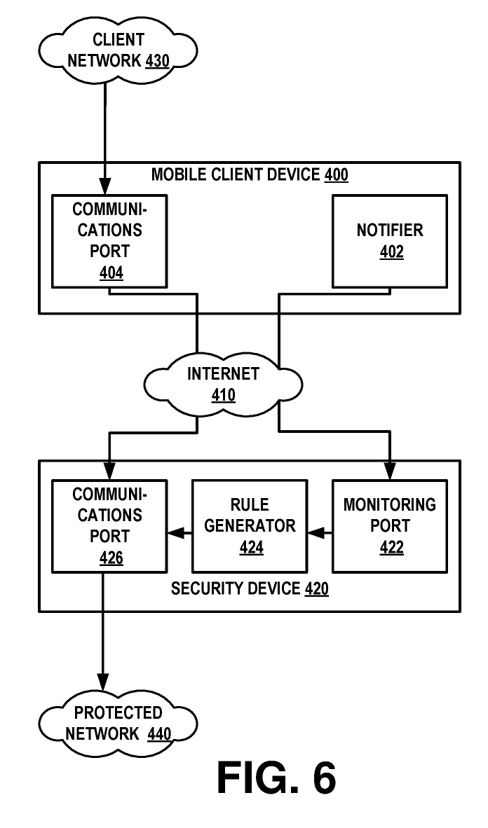

Referring now to FIG. 6, with continuing reference to the foregoing figures, another embodiment is depicted for masking a network port. This exemplary operating environment includes a mobile client device 400 that configures and implements a notifier 402 and a communications port 404. Mobile client device 400 connects over the internet 410 to a security device 420 that implements a monitoring port 422, rules generator 424, and communications port 426. The security device 420 connects to a protected network 440.

A client network 430 is also connected to the mobile client device 400. The client network 430 can communicate and can exchange information with the protected system 440 through the mobile client device 400 and the security device 420. In this exemplary embodiment, the client network 430 is a virtual private network or VPN, but it should be understood that the client network 430 can be any suitable private or public network.

In this embodiment, the mobile client device 400 is associated with a source network IP address. The mobile client device 400 implements and utilizes the notifier 402 to call the port monitor 422 on the security device 420.

As discussed, the security device 420 implements and utilizes the rule generator 424 to create or to modify rules that allow devices to access the protected network 440. In embodiments, the rule generator is a process contained within a masking module 350. The rules can be implemented to restrict access by the mobile client device 400 to periods of time in which the mobile client device 400 is associated with a certain IP address or group of IP addresses. The security device 420 can otherwise restrict access to the communications port 426 based upon other information associated with the source IP address.

The security device 420 controls the communications port 426 which communicates with the communications port 404 on the mobile client device 400. The security device 420 can restrict access to the communications port 426 by keeping the communications port 426 restricted (or masked) until the mobile client device 400 enables the notifier 402 to make a port call. As a result, the security device 400 can make the communications port 426 unavailable to protect the protected network 440 from scans, probes, hacking attempts and denial of service attacks, for example, until such exposure is necessary.

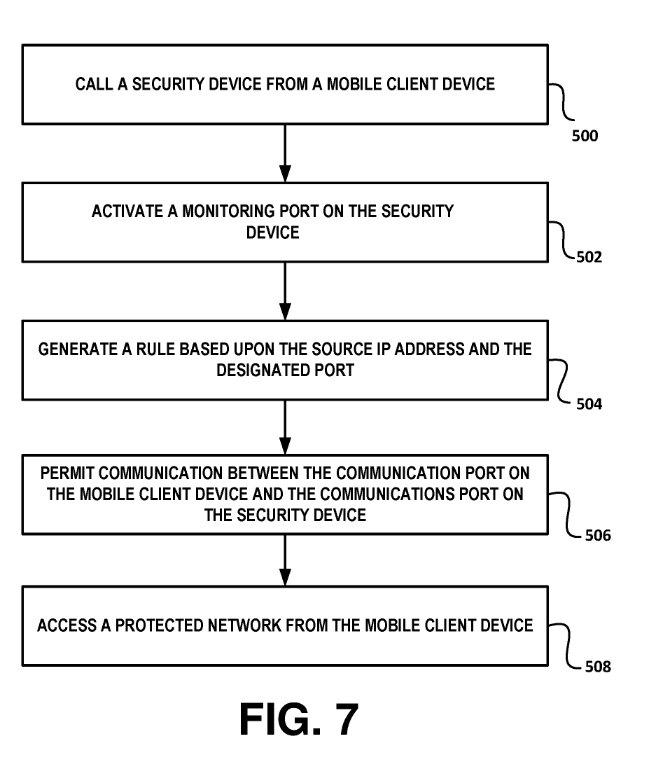

Referring now to FIG. 7, with continuing reference to the forgoing figures, a process is shown that illustrates the operation of the embodiment of the invention shown in FIG. 6. Through this process, the mobile client device 400 can access the protected network 440 through the security device 420. In this exemplary embodiment, mobile client device 400 initiates the process by calling the security device 420 at 500. The mobile client device 400 can configure and implement the notifier 402 to call the monitoring port 422 on the security device 420.

A monitoring port can be activated on a security device at 502 to start a rule generation process. In this exemplary embodiment, the security device 420 can activate the port monitor 422 after the notifier 402 on the mobile client device 400 initiates a network port call. The security device 420 can configure and implement the rules generator 424 after the port call.

A rule is generated that is based on the source IP address and the designated port at 504. In this exemplary embodiment, the rules generator 424 generates rules based upon the source IP address of the mobile client device 400 and upon other related information in order to activate the designated communications port 426. The rules generator 424 can add rules or modify rules, as necessary. In some embodiments, the rules generator 424 also includes a destination IP address and port. For example, the mobile client device 400 may send a series of port calls to a first IP address, whereupon the masking module and/or rules generator 424 creates a rule for a different IP address and port. The mobile client device 400 then knows to look at the IP address and port identified by the masking module or rules generator 424.

Communication between a communications port on the mobile client device and the communications port on the security device can be permitted at 506. In this exemplary embodiment, the security device 420 can permit the communications port 426 to communicate with the communications port 404 to allow the mobile client device 400 to access the protected network 440.

A protected network can be accessed from the mobile client device at 508. In this exemplary embodiment, the protected network 440 can be accessed from the mobile client device 400 through the communications port 426. The security device 420 can be configured to restrict access to communications port 426 to specific IP addresses to prevent unauthorized access to the protected network 440. Additionally, the security device 420 can make the communications port 426 inaccessible to the public to stop exposure to the world, which can solve mobility problems for the mobile client device 400.

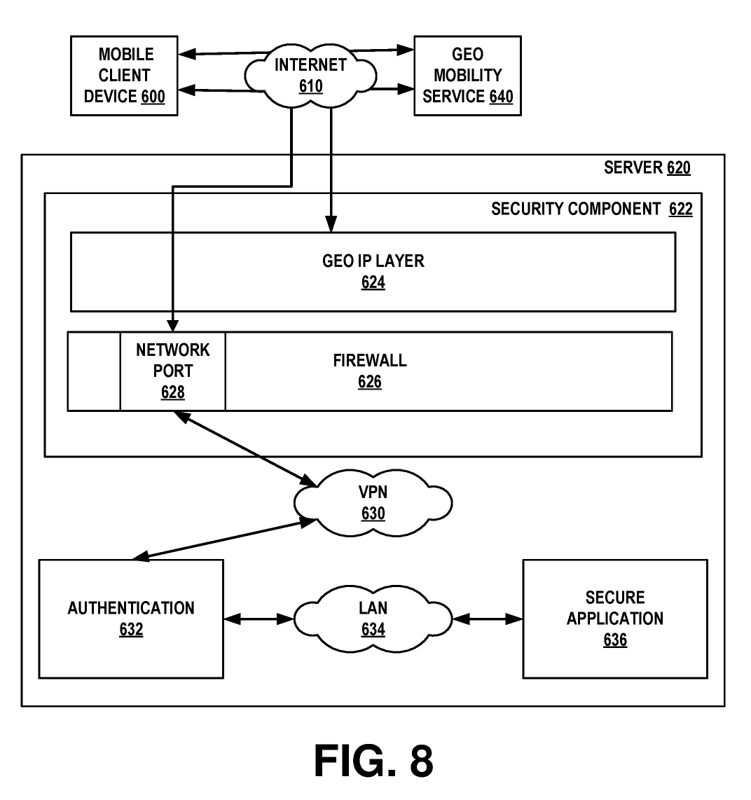

Referring now to FIG. 8 with continuing reference to the foregoing figures, another exemplary operating environment for masking a network port is shown. In this embodiment, a mobile client device 600 connects over the internet 610 to a server 620 that implements aspects of another embodiment of the invention. The mobile client device 600 can be installed on a laptop, a tablet, a phone, or other similar devices.

The server 620 can include a geo-capable security component 622 that includes a firewall 624, a geo-ip layer 626, and at least one network port 628 in the firewall 624. The network port 628 can provide access to VPN 630, authentication component 632, LAN 634, and secure application 636. The server 620 can be implemented on-premises or as a hosted solution.

The server 620 configures and implements geo-mobility service 640 for communicating with the mobile client device 600. The mobile client device 600 reports back to the geo-mobility service 640, as it moves from network to network or country to country. The geo-mobility service 640 can be located at the same geographic location with the server 620 or on a remote server connected to the Internet.

The mobile client device 600 reports its current IP address to the geo-ip layer 624 through the geo-mobility service 640 at regular intervals or upon request by the server 620. The mobile client device 600 is registered with the geo-mobility service 640 after a mobile agent software application is installed on the mobile client device 600.

When the mobile client device 600 is in a protected environment, the mobile client device 600 will call back to geo-mobility service 640 to indicate that the IP address has changed for the mobile client device 600.

Once the mobile client device 600 receives a new IP address, the mobile client device 600 calls, via a secure token, certificate, or similar device, to the geo-mobility service 640 to request a connection to the secure application 636. The geo-mobility service 640 and/or the geo-ip layer 624 can write new rules for the geo-ip layer 624. The new rules will provide the mobile client device 600 with unimpeded access to the secure application 636.

The geo-mobility service 640 can communicate, directly, with the geo-ip layer 626. In embodiments, the geo-ip layer 626 can include an API addressable geo-capable secure device. The geo-ip layer 626 can activate/deactivate the network portal 628 or randomize the network portal 628 to permit access to authorized users and to prevent access by unauthorized attackers.

The geo-ip layer 626 has the ability to configure and implement a rules engine that dynamically creates location-based network rules within the security component 622 to permit access from the mobile client device 600 to the next layer of security, which includes VPN 630, authentication component 632, LAN 634, and secure application 636, for exchanging data.

The network portal 628 can remain active until the data exchange process and/or the API calls are complete. Once until the data exchange process and/or the API calls are complete, the network portal 628 can be turned off.

The rules can be replicated to provide smooth communications for the mobile client device 600 through the server 620. As a result, the mobile client device 600 can be locked out from the network portal 628 in the event the mobile client device 600 is compromised, regardless of location. For example, the server 620 can lock out the mobile client device 600 after receiving requests from outside of the United States when the geo-mobility service 640 indicates that the mobile client device 600 is located in the United States. Additionally, the server 620 can notify an administrator should it appear that the mobile client device 600 is not in its expected location.

The server 620 can maintain records of the locations of the mobile client device 600 and of access to the network portal 628. These records provide a system administrator with the ability to manage system, insight to the mobile environment throughout an enterprise, and tighter controls for traveling users. Moreover, the server 620 can implement and utilize a tracking map by tracking the IP address and/or geo-coordinates of the mobile client device 600 and plotting the location and other pertinent network information in a suitable form.

The geo-mobility service 640 can maintain the IP and traffic history of the mobile client device 600. A network administrator can query this information for trending and reporting purposes. The geo-mobility service 640 and/or the security component 622 can terminate access to the secure application 636 via a console. Then, the geo-mobility service 640 and/or the security component 622 can notify the mobile client device 600 that access has been revoked.

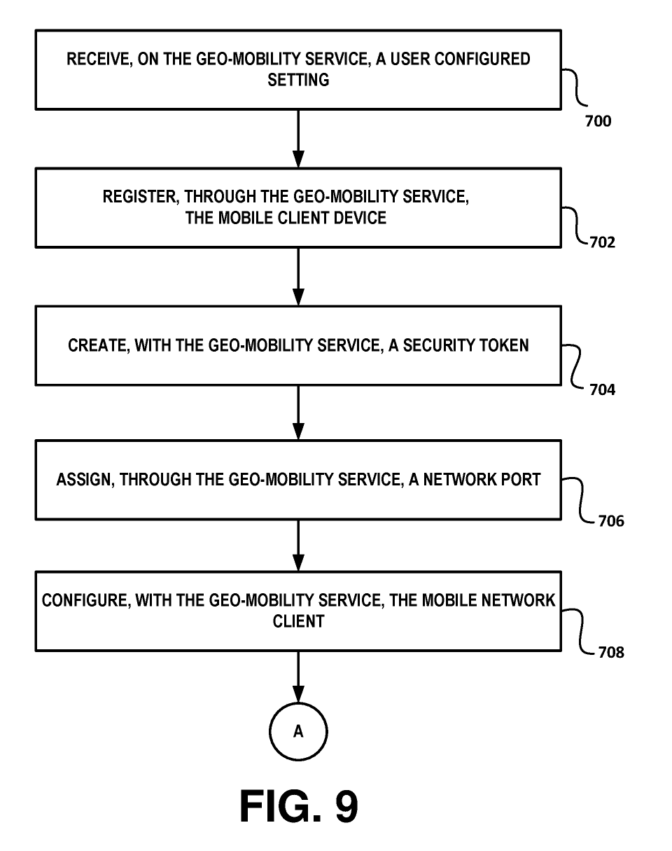

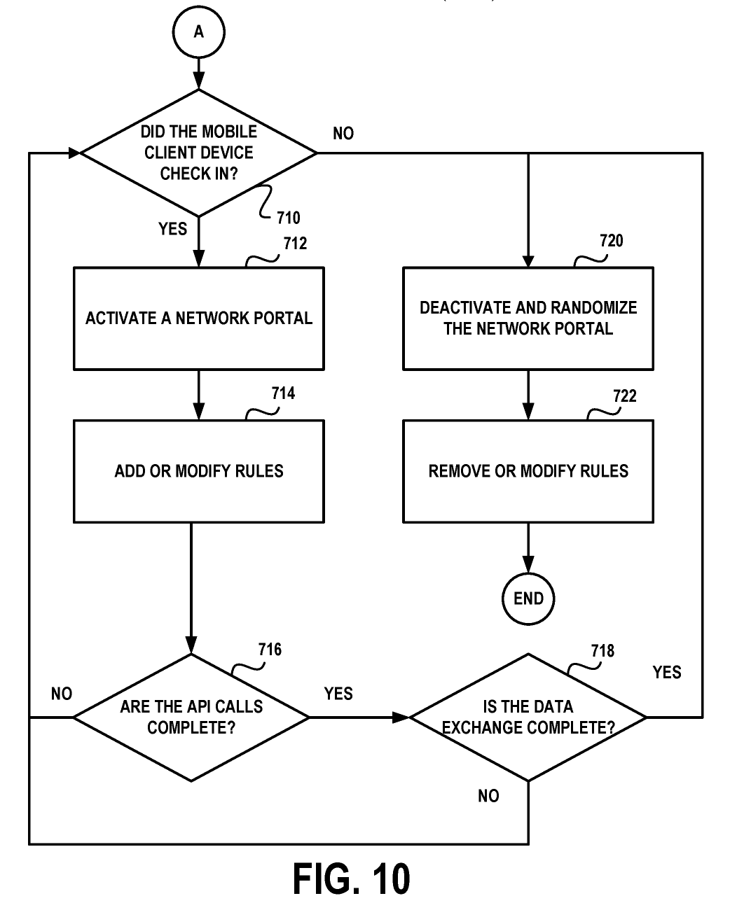

Referring now to FIGS. 9 and 10 with continuing reference to the foregoing figures, a process is shown that illustrates the operation of the embodiment of the invention shown in FIG. 8. Through the process, a user can pre-configure the geo-mobility service 640 to eliminate the need to expose static ports on a network security perimeter.

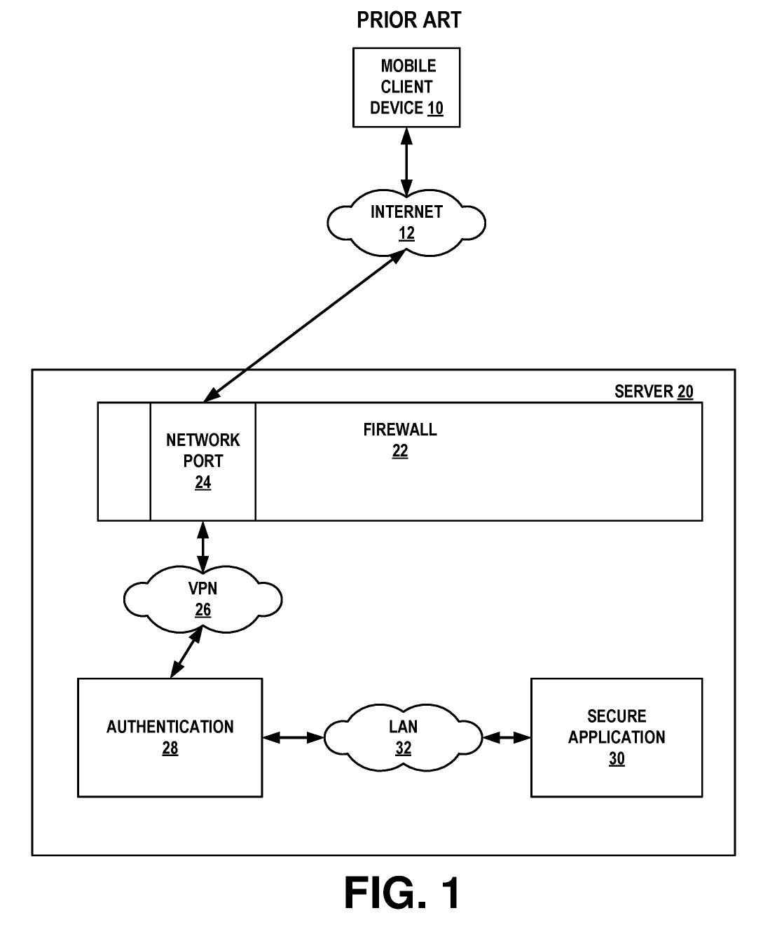

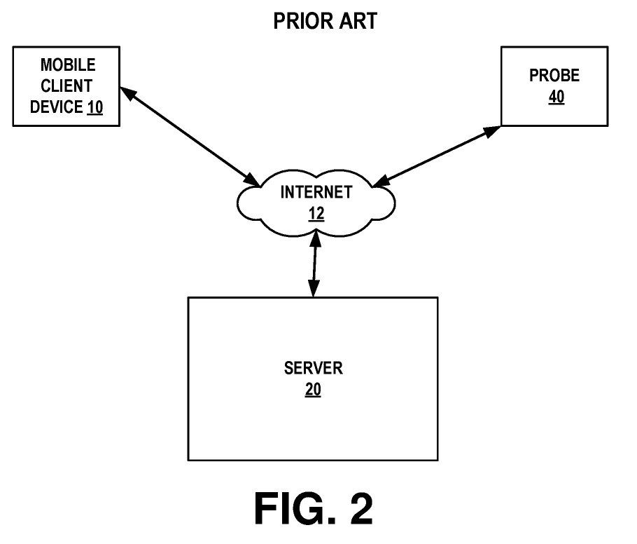

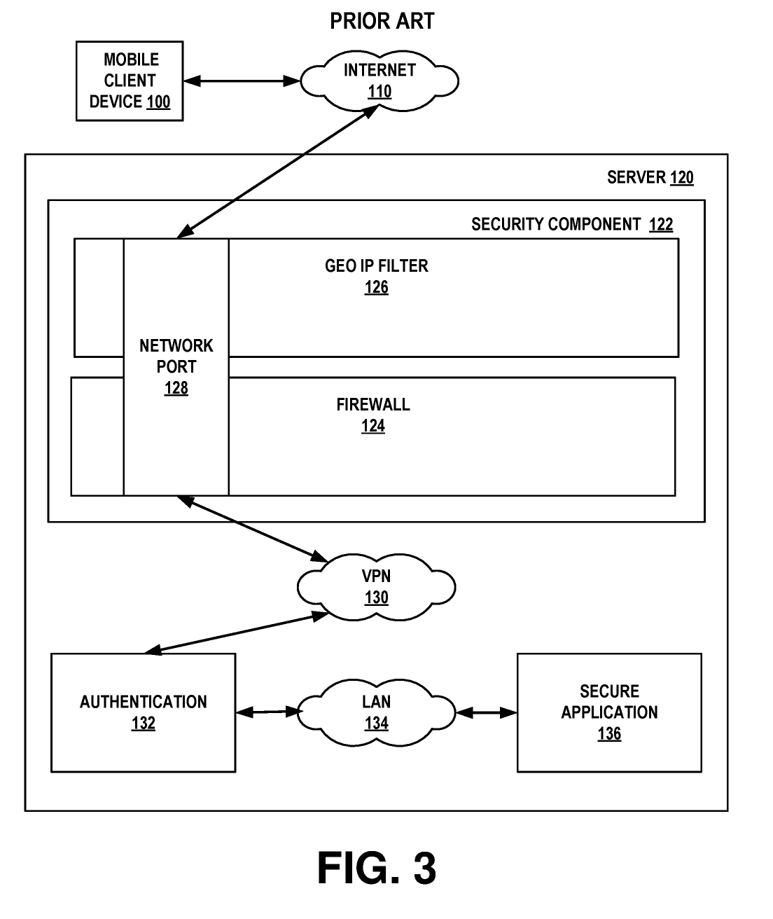

At 700, the geo-mobility service 640 receives a user-configured setting or group of settings. The settings allow the user to pre-configure the geo-mobility service 640 to select from a dynamic assignment of network ports or a predefined set of network ports for the mobile client device 600. The use of a pre-configured geo-mobility service 640 reduces the probability of the network portal 628 being identified as a vulnerable communication port, as can occur with the servers 20 and 120 shown in FIGS. 1-3

At 702, the mobile client device 600 can be registered through the geo-mobility service 640. Next, the mobile client device 600 and the geo-mobility service 640 exchange security tokens at 704 to ensure that the geo-mobility service 640 can verify the identity of the mobile client device 600. Through the exchange of tokens, the mobile client device 600 can execute a security handshake with the geo-mobility service 640 at the appropriate time. The security tokens can be keys, certificates, or other similar devices.

At 706, the geo-mobility service assigns one or more network ports, such as network port 628 for the mobile client device 600. The geo-mobility service 640 is configured at 708 with identified internal and external networks, location based operating limits, location based network ports, or publicly available services.

At 710, the geo-mobility service 640 receives periodic check-ins from the mobile client device 600. The mobile client device 600 will begin making periodic check-ins at 710 after the geo-mobility service 640 is configured. The geo-mobility service 640 listens for the mobile client device 600, collects pertinent network information, and can record any changes to its location or network status in a database through these check-ins.

The mobile client device 600 can use a software application or app to communicate with its home network while it is reporting information to the geo-mobility service 640. The application or app can report the location (i.e., IP address) of the mobile client device 600 to the server 620 via a secure process. The application or app can be integrated with a GPS system within the mobile client device 600.

The geo-mobility service 640 can verify that the mobile client device 600 is an authorized device by using a security handshake that was generated when the mobile client device 600 was registered with geo-mobility service 640. The mobile client device 600 will continue to check-in with the geo-mobility service 640 while it is within the allowable geographic areas for the network.

At 712, the geo-mobility service 640 will activate network portals or ports, such as network portal 628, after the mobile client device 600 performs a check-in function. Then, the geo-mobility service 640 will cooperate with the geo-ip layer 626 to create or to modify rules at 714. The rules allow traffic to pass from the mobile client device 600 through the network portal 628, so that the mobile client device 600 can establish a secure connection with the secure application 636.

The geo-mobility service 640 will continue to dynamically update the rules with the geo-ip layer 626 to the extent necessary to continue to maintain a secure connection at 716. The mobile client device 600 can exchange data with secure application 636 as long as a secure connection is maintained at 718.

Once the mobile client device 600 stops exchanging data with the secure application 636 or leaves the secure perimeter of the network, the geo-mobility service 640 will initiate the deactivation of the network portal 628 at 720. Then, the geo-mobility service 640 will cooperate with the geo-ip layer 626 to eliminate and/or to modify rules at 722.

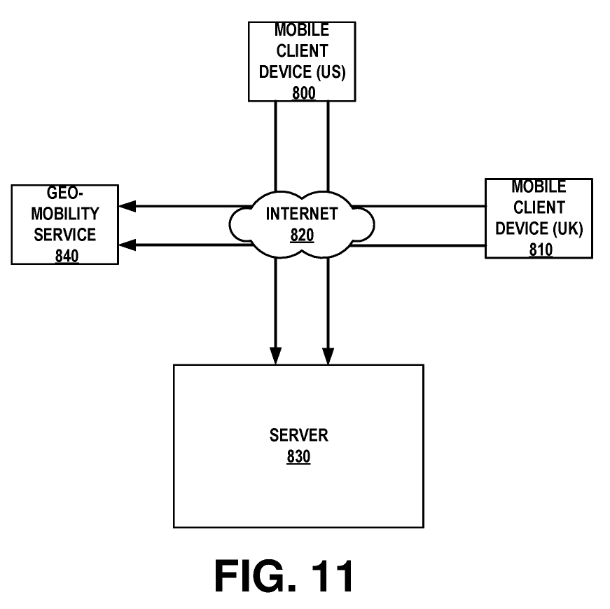

Referring now to FIG. 11 with continuing reference to the foregoing figures, an operating environment is illustrated that implements aspects of the embodiment shown in FIG. 8 to further illustrate the masking of a network port or portal. In this exemplary embodiment, mobile clients 800 and 810 can connect over the internet 820 to server 830 and geo-mobility service 840.

Server 830 and geo-mobility service 840 are essentially identical to server 620 and geo-mobility service 640 shown in FIG. 8. Mobile client device 800 can be located in different countries, such as the US and UK.

Server 830 is an intelligent system that has the ability to mask a network portal, such as network portal 628 shown in FIG. 8, to outside exposure, automatically, once mobile client devices 800 and 810 are within a protected network security perimeter. As a result, server 830 eliminates the need to open network portal 628 for unnecessary reasons and provides better protection to VPN 630, authentication component 632, LAN 634, and secure application 636 shown in FIG. 8. Access to server 830 can based upon the active location or the IP address of the mobile client devices 800 and 810.

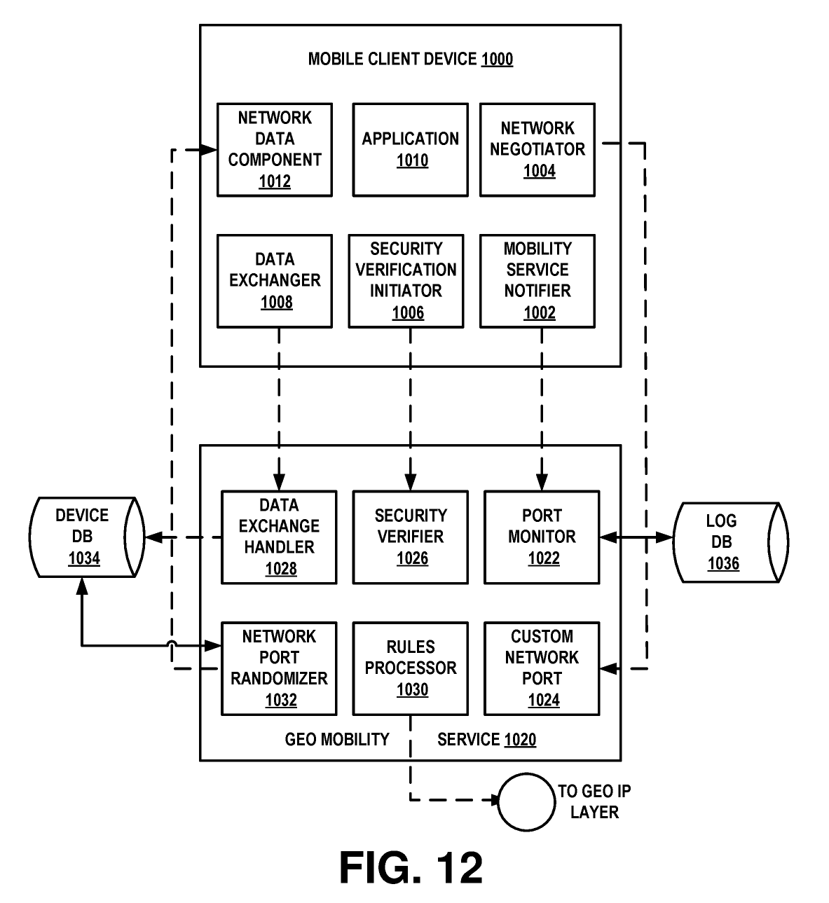

Referring now to FIG. 12 with continuing reference to the foregoing figures, an operating environment is illustrated that implements aspects of the embodiment shown in FIG. 8 to further illustrate the masking of a network port. In this exemplary embodiment, a mobile client device 1000 includes a mobility service notifier 1002, network negotiator 1004, a security verification initiator 1006, a data exchanger 1008, a device application 1010, and a network data component 1012.

In certain embodiments, geo-mobility service 1020 includes a listener or port monitor 1022, a custom network port 1024, a security verifier 1026, a data exchange handler 1028, a rules processor 1030, and a network port randomizer 1032. The geo-mobility service 1020 communicates with a device database 1034 and a log database 1036.

The mobile service notifier 1002 transmits calls to predetermined network ports in a particular sequence to notify the port monitor 1022 that the mobile client agent 1000 is authorized to use a network port to communicate with a protected network.

The network negotiator 1004 connects to the custom network port 1024 to set the parameters of a communications channel between the mobile client device 1000 and the geo-mobility service 1020. Through this connection, the network negotiator 1004 accomplishes a network handshake with the custom network port 1024.

The security verification initiator 1006 connects with the security verifier 1026 to ensure that the connection is secure and authorized. Once a secure connection is established, the data exchanger 1008 can send and receive data between the software application on the mobile device 1010 and the data exchange handler 1028. The application 1010 can be configured to communicate with a secure application residing on a secure server.

Next, the rules processor 1030 can communicate with a geo-ip layer, such as the geo-ip layer 624 shown in FIG. 8, to initiate a process to write or remove network rules as necessary.

Once the data exchanger 1008 has completed the transfer of data to the data exchange handler 1028, or, alternatively, once a session has been established, the network port randomizer 1032 will change the sequence in ports for that destination network port. The network port randomizer 1032 will then send the new randomized port combination to the network data component 1012 on the mobile client device 1000 so that when the client device changes networks or the session expires, the client 1000 will need to use the new port combination sequence to access the protected network.

The data exchange handler 1028 and the network port randomizer 1032 communicates with the device database 1034. The device database 1034 stores the information relating to the mobile client device 1000, such as the device id 1038, the IP address 1040, the time 1042, the geo coordinates 1044, and the network port 1046.

The port monitor 1022 communicates with the log database 1036 to log port attempts and other network traffic 1048.

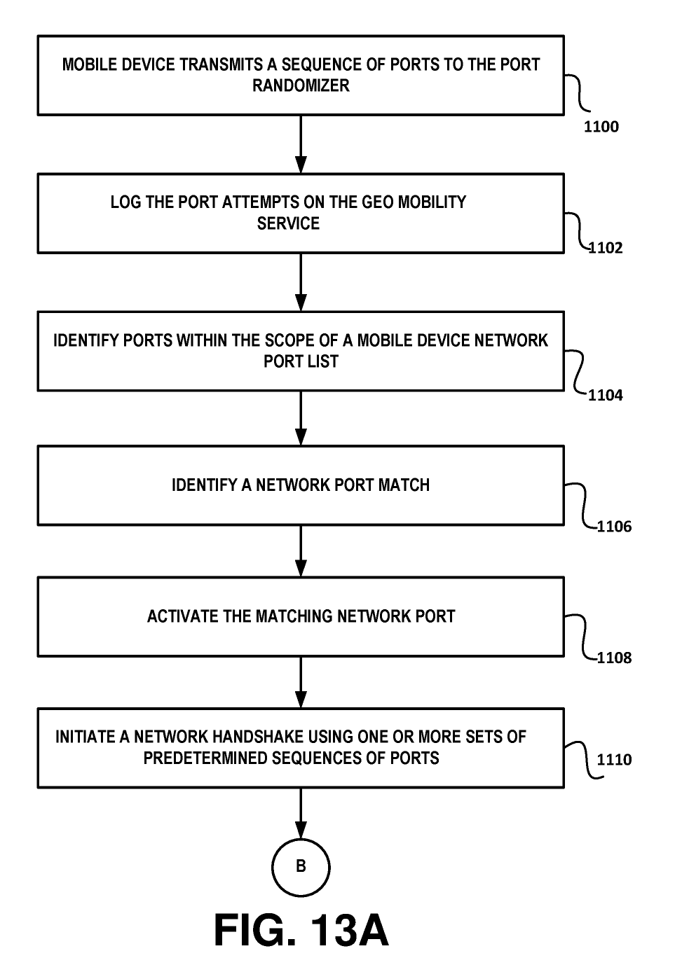

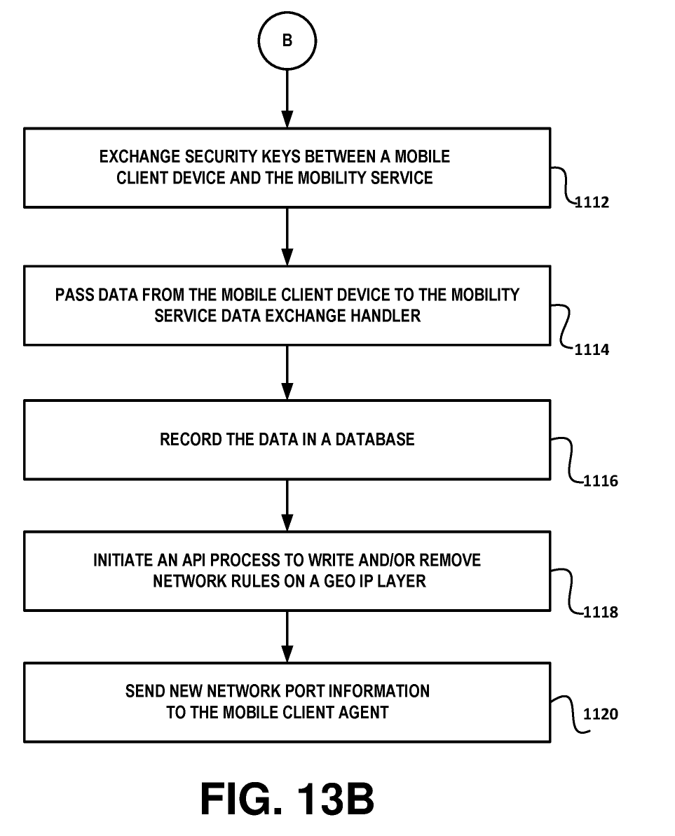

Referring now to FIGS. 13A-13B with continuing reference to the foregoing figures, a process is shown that illustrates the interaction of a mobile client device with a geo-mobility service protecting a network. A mobile client device transmits a predetermined sequence of ports to the port randomizer at 1100. For example, mobile client device 600 or 1000 can transmit one or more sets of sequenced network ports using readily available tools like NMAP or some other custom network port generating application to call the geo-mobility service 640 or 1020.

The geo-mobility service can utilize a port monitor to log port attempts at 1102, identify ports within the scope of the mobile devices network port list at 1104, and identify a network port match at 1106. For example, the geo-mobility service 1020 can configure and utilize port monitor 1022 to log port attempts in database 1036. Then, the port monitor 1022 can identify the correct sequence of ports to determine which ports can be used by the mobile client application 1000 to access a secure network,

The geo-mobility service can activate the network port at 1108 by creating a rule that contains user configurable limits such as time frame, destination IP, and port. For example, the geo mobility service 640 and geo-ip layer 624 can cooperate to activate network port 628.

The mobile client device initiates a network handshake using a one or more sets of predetermined sequences of network ports at 1110. For example, the mobile client device 1000 can be configured with the correct sequence of ports which the network negotiator 1004 transmits to accomplish a network handshake with the custom network port or ports 1024.

The mobile client device and the geo-mobility service exchange security keys at 1112. Then, the mobile client device passes its data to the geo-mobility service data exchange handler at 1114. In this exemplary embodiment, the mobile client device 1000 can configure and implement security verification initiator 1006 to connect to the security verifier 1026 to exchange security keys. Once a secure connection is established, the data exchanger 1008 can send data from the application 1010 to the data exchange handler 1028.

In certain embodiments, the geo-mobility service data exchange handler records this information to a database at 1116. In this exemplary embodiment, the geo-mobility service 1020 configures and implement data exchange handler 1028 to record the information in the device database 1034.

In certain embodiments, the geo-mobility service initiates a rules process, such as an API process to write and or remove network rules to an API addressable security device the mobile client network information at 1118. In this exemplary embodiment, the geo-mobility service 1020 configure and implements API processor 1030 to communicate with a geo-ip layer 624 to initiate an API process to write and or remove network rules to an API on the geo-ip layer 624.

The geo-mobility service port randomizer sends new network port information, whether single port or a sequence of ports, to the mobile client device at 1120. The new network port or port sequence is to be used when the mobile client changes its IP address. For example, in certain embodiments, the geo-mobility service 1020 will configure and implement the network port randomizer 1032, which will update the mobile client with the new network port or port sequence needed once the client changes networks or the session times out on the current network port 628.

In a particular exemplary embodiment, network ports are used not only for communication for services such as web, mail, and vpn services, but they can be re-purposed as a lock that is only unlocked through the use of a communicated combination of ports. Additionally, combinations of ports can be used to identify particular external or mobile devices, which, in turn, can be used to identify the individual who is trying to access a protected network.

Continuing with this embodiment, when a software app (an “agent”) is installed on a user's device, it registers itself with a service on a security device installed on the edge of a protected network. The service then generates and issues key port assignments for identification of that device. In some embodiments, the security device also generates an encryption token.

When the user's device subsequently attempts to access the protected network, it makes a request to access the network by providing its key port assignments to identify itself. The monitor module on the security device verifies the key port assignments and a token authenticator verifies the encryption token. If the user's device is identified and the encryption token is accepted, the device then sends a series of port requests to the device. By way of example, the first request may be to port 1234, the second 12789 and the third request is to port 32891. If all these port requests match the required sequence and they are submitted within the proper time frame, the rules generator writes a rule to allow the device at the user's IP address to access the protected network and the user may then access a previously unavailable network port on the protected network.

The rules generator then writes a rule to a tracker table that indicates that the authorized device is allowed to access the protected network from a certain IP address for a set period of time. In an embodiment, the rule will expire after the set period of time has elapsed. If the user subsequently attempts to access the protected network from a different IP address, the process repeats. If access is granted as a result of the attempt from the new IP address, the rules generator will remove the old rule and replace it with a new one for the new IP address.

I claim:

1. A network security system for ensuring that only authorized devices can communicate with a protected computer network, the network security system comprising:
at least one processor configured to execute computer-executable instructions and memory storing computer-executable instructions, the instructions configured to implement:
a security device having a monitor module and at least one monitoring port, wherein the monitor module is configured to receive a request from a remote device to access the protected computer network, the request comprising a sequence of network port calls, the monitor module is further configured to verify the sequence and provide the remote device with access to a port to communicate with the protected computer network.

2. The network security system of claim 1, wherein the sequence of network port calls identifies an authorized user of the remote device.

3. The network security system of claim 1, further comprising a software application installed on the remote device, the application configured to communicate with the security device via a service.

4. The network security system of claim 3, wherein the application registers the remote device with the service and the service then generates and issues key port assignments for subsequent identification of the remote device.

5. The network security system of claim 4, wherein the security device further generates an encryption token to be used by the remote device.

6. The network security system of claim 1, wherein the security device further comprises a rules generator for writing rules to allow the remote device to access the protected computer network from at least one of a specific IP address and a set amount of time.

7. A computer system for providing security to a computer network, the computer system comprising:
at least one processor configured to execute computer-executable instructions; and
memory storing computer-executable instructions configured to implement:
a geo-mobility service for communicating with a mobile client device having a mobile client agent installed thereon; and
a security component having at least one of a geo-ip layer and a firewall with a network port therein;
wherein the geo-mobility service receives reports containing location information from the mobile client agent;
wherein the geo-mobility service transmits the location information to the geo-ip layer;
wherein the geo-ip layer activates the network port in response to the location information to provide access to the computer network for the mobile client agent.

8. A computer-implemented method for providing security to a protected computer network, the computer-implemented method comprising:
receiving, on a network security device, a request from a mobile client agent to access the protected computer network, the request containing authentication information for the mobile client agent,
verifying that the mobile client agent is authorized to access the protected computer network;
generating one or more rules to activate a communications port on the network security device, and
activating the communications port to allow the mobile client agent to access the protected computer network.

9. The method of claim 8, further comprising installing the mobile client agent on a mobile client device and registering the mobile client agent with a service on the network security device.

10. The method of claim 9, wherein the step of verifying comprises checking key port assignments submitted by the mobile client agent against those assigned to the device during registration.

11. The method of claim 9, further comprising the step of verifying an encryption token provided by the mobile security agent during registration.

12. The method of claim 8, further comprising receiving a series of port access requests and comparing them to a predetermined series of port numbers.

13. The method of claim 8, wherein the step of verifying a request from a mobile client agent comprises receiving a plurality of key port assignments and confirming that the agent has previously been registered with the device.

14. The method of claim 8, wherein the step of generating one or more rules includes generating a rule limiting the length of time that the mobile client agent can access the protected computer network.

15. The method of claim 8, wherein the step of generating one or more rules includes generating a rule revoking authorization for the device to access the protected computer network if access is attempted from a different IP address or location.

16. A computing device for providing access to a computer network having a security component having a geo-ip layer, a firewall, and a network portal within the firewall, the computing device comprising:
at least one processor configured to execute computer-executable instructions; and
memory storing computer-executable instructions configured to implement:
a port monitor for communicating with a mobile client agent to determine the location of the mobile client agent;
a security verification receiver for exchanging security keys with the mobile client agent;
a data exchange handler for exchanging data with the mobile client agent; and
an API processor for connecting to the geo-ip layer to modify the rules for the firewall to active the network portal to allow the mobile client agent to access the computer network.
